(19) United States
(12) Patent Application Publication
(10) Pub. No.: US 2006/0023392 A1
(43) Pub. Date: Feb. 2, 2006

(54) Ion generation apparatus

(75) Inventors: Young Sik Park, Seoul (KR); Jun-Hyoun Kwon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/117,497

(22) Filed: Apr. 29, 2005

(30) Foreign Application Priority Data
Jul. 27, 2004 (KR) 2004-58857

(51) Int. Cl. H01T 23/00

(52) U.S. Cl. 361/230

(57) ABSTRACT

An ion generation apparatus. The ion generation apparatus includes: an ion generator including a positive ion generation electrode and/or a negative ion generation electrode, for receiving a high voltage to generate ions; a high voltage generator for applying a high voltage to the ion generator; and a controller for changing the high voltage applied to the ion generator. The ion generation apparatus can easily change the quantity of positive(+) or negative(−) ions generated from the ion generator by changing a high voltage applied to an electrode of the ion generator so that a user can conveniently use the ion generation apparatus irrespective of installation environments.

### CROSS-REFERENCE TO RELATED APPLICATION

This application claims the benefit of Korean Patent Application No. 2004-58857, filed on Jul. 27, 2004 in the Korean Intellectual Property Office, the disclosure of which is incorporated herein by reference.

### BACKGROUND OF THE INVENTION

1. Field of the Invention

The present invention relates to an ion generation apparatus, and more particularly to an ion generation apparatus for changing a high voltage applied to an electrode of an ion generator including a component for generating positive/negative ions.

2. Description of the Related Art

Typically, a negative ion generator has been installed in electronic devices such as an air cleaner, such that the negative ions generated from the negative ion generator are provided to a room. However, there is a limitation in fully sterilizing bacteria using only the negative ions generated from the negative ion generator, such that an ion generation device for generating positive and negative ions to sterilize such bacteria has recently been developed such that the sterilizing power of the ion generation device can be improved. The ion generation device applies a high voltage to an ion generator including a pair of positive and negative electrodes, such that it generates positive ions (e.g., hydrogen gas) and negative ions (e.g., O2-).

However, the aforementioned ion generation device has been designed not to change the high voltage applied to the electrodes after deciding to apply a predetermined high voltage to the electrodes, such that it cannot change ion categories and a quantity of ions generated from the ion generation device. Therefore, although there is a need for the quantity of generated ions to be newly established due to installation environments of the ion generation device, the conventional ion generation device is unable to properly cope with the above problem, resulting in deterioration of use efficiency of the ion generation device.

### SUMMARY OF THE INVENTION

Therefore, it is an aspect of the invention to provide an ion generation device for changing a high voltage applied to electrodes, resulting in increased use efficiency of the ion generation device.

Additional aspects and/or advantages of the invention will be set forth in part in the description which follows and, in part, will be obvious from the description, or may be learned by practice of the invention.

In accordance with the invention, the above and/or other aspects can be achieved by the provision of an ion generation apparatus comprising: an ion generator including at least one of a positive ion generation electrode and a negative ion generation electrode, for receiving a high voltage to generate ions; a high voltage generator for applying a high voltage to the ion generator; and a controller for changing the high voltage applied to the ion generator.

Preferably, but not necessarily, the high voltage generator includes a sine wave generator for generating a sine wave signal, and the controller includes one of a frequency setup unit for establishing a frequency of the sine wave signal and a duty-cycle setup unit for establishing an on-time duty cycle of the sine wave signal.

Preferably, but not necessarily, the ion generation apparatus further comprises an entry unit for allowing a user to establish the frequency or on-time duty cycle of the sine wave signal having the high voltage, in which the controller changes the sine wave signal having the high voltage according to information established by the entry unit.

Preferably, but not necessarily, the ion generation apparatus further comprises a high voltage generator which includes a square wave generator for generating a square wave signal, and the controller includes at least one of a frequency setup unit for establishing a frequency of the square wave signal and a duty-cycle setup unit for establishing an on-time duty cycle of the square wave signal.

Preferably, but not necessarily, the ion generation apparatus further comprises an entry unit for allowing a user to establish the frequency or on-time duty cycle of the square wave signal having the high voltage, in which the controller changes the sine wave signal having the high voltage according to information established by the entry unit.

Preferably, but not necessarily, the ion generation apparatus further comprises a storage unit for storing information corresponding to the high-voltage sine wave signal or the high-voltage square wave signal and information corresponding to the quantity of generated ions.

### BRIEF DESCRIPTION OF THE DRAWINGS

These and/or other aspects and advantages of the invention will become apparent and more readily appreciated from the following description of exemplary embodiments, taken in conjunction with the accompanying drawings of which:

FIG. 1 is a view illustrating the appearance of an ion generation device according to the present invention;

FIG. 2 is a cross-sectional view illustrating the ion generation device of FIG. 1;

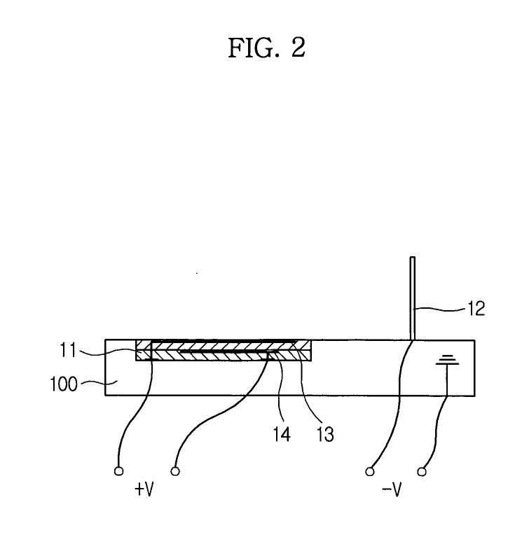

FIG. 3 is a view illustrating hydrogen gas generated from a ceramic plate;

FIG. 4 is a block diagram illustrating an ion generation device according to a preferred embodiment of the present invention;

FIG. 5a is a graph illustrating a frequency variation of a sine wave signal;

FIG. 5b is a graph illustrating variations in frequency and duty cycle of a sine wave signal;

FIG. 5c is a graph illustrating a variation in duty cycle of a sine wave signal;

FIG. 6 is a block diagram illustrating an ion generation device according to another preferred embodiment of the present invention;

FIG. 7a is a graph illustrating a frequency variation of a square wave signal; and

FIG. 7b is a graph illustrating a variation in duty cycle of a square wave signal.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The embodiments are described below to explain the present invention by referring to the figures.

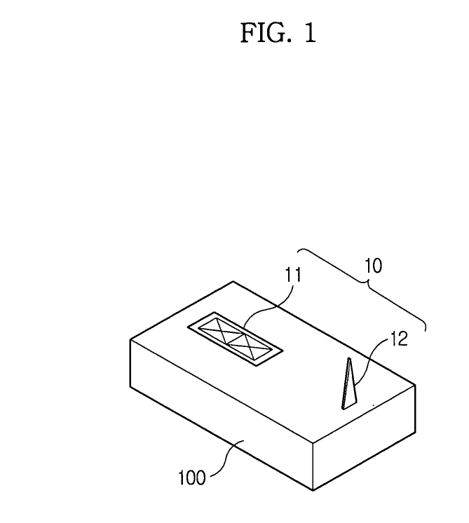

As shown in FIGS. 1˜2, the ion generation device according to the present invention mounts an ion generator 10 for generating ions on a support 100. The ion generator 10 includes a positive ion generator 11 for generating positive ions, and a negative ion generator 12 spaced apart from the positive ion generator 11 by a predetermined distance for generating negative ions.

An opening in which the positive ion generator 11 is installed is placed on the top of the support 100, such that the positive ion generator 11 is installed in the opening. The positive ion generator 11 is adapted to generate positive ions. A discharge electrode 13 is provided at the inner upper part of the positive ion generator 11, and an induction electrode 14 is provided at the center of the positive ion generator 11. The remaining parts other than the discharge electrode 13 and the induction electrode 14 are formed of ceramic material, such that they form a protective layer.

If a negative(−) high voltage is applied to the negative ion generator 12, such as a negative ion generation electrode, the negative ion generator 12 emits electrons. These electrons are combined with oxygen molecules (O₂ ) contained in the air, such that a superoxide anion O₂⁻ is generated.

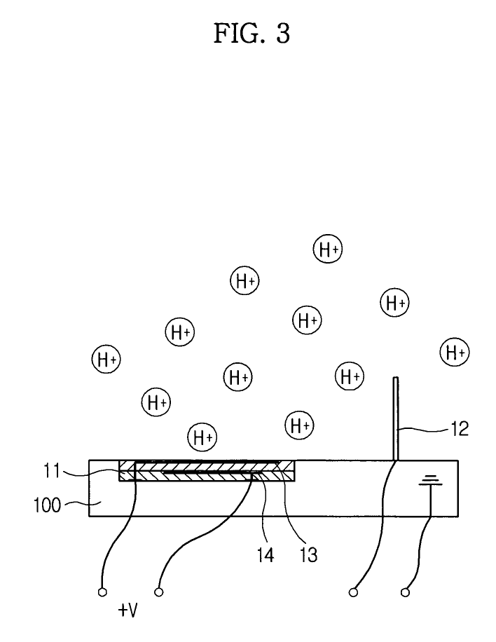

If a positive(+) high voltage is applied to the discharge electrode 13 and the induction electrode 14, moisture contained in the air is ionized by a plasma discharge phenomenon as shown in FIG. 3, such that ions such as hydrogen ions are generated in the vicinity of the positive ion generator 11.

If the positive(+) high voltage (i.e., a sine or square wave) is applied to the positive ion generator 11, and at the same time the negative(−) high voltage is applied to the negative ion generator 12, the positive ion generator 11 generates hydrogen ions, etc., and the negative ion generator 12 generates electrons and a superoxide anion O₂⁻. The hydrogen ions generated from the positive ion generator react with the electrons emitted from the negative ion generator, such that a hydrogen atom is formed.

When the hydrogen atom and the superoxide anion O₂⁻ are formed, a hydroperoxy radical (O—O—H) is formed. The O₂⁻ electron is offset by static electricity of bacteria. The O—O—H radical takes a hydrogen atom away from a protein indicative of a structural component of a cell membrane of the bacteria, such that it makes water. A protein molecule of the cell membrane from which the hydrogen atom is taken away is destroyed, and the cell membrane is also destroyed in such a way that sterilization is carried out.

As a frequency or on-time duty cycle of the positive(+) high voltage applied to the discharge electrode 13 and the induction electrode 14 is changed, the quantity of generated ions is regulated according to the variation in either the frequency or the on-time duty cycle of the positive(+) high voltage.

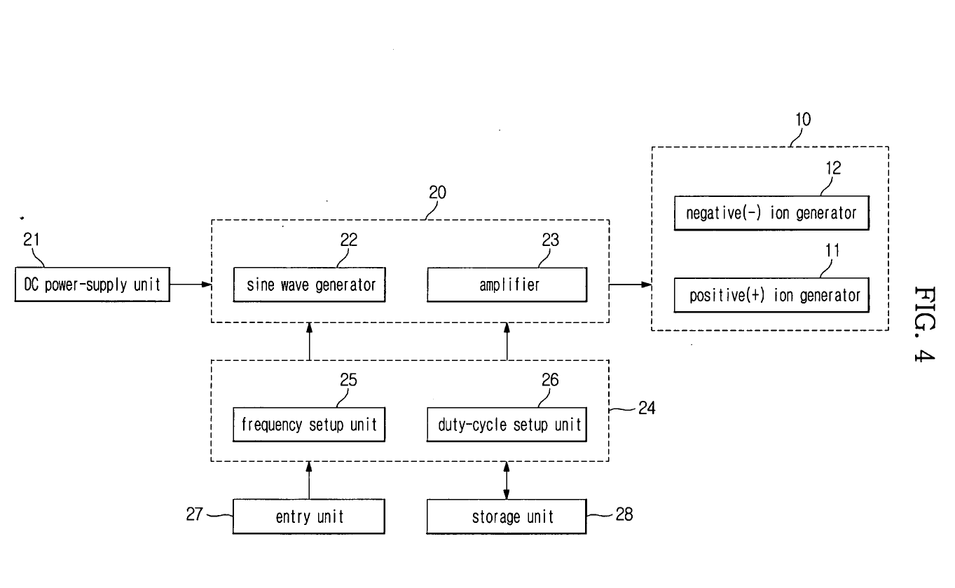

If a sine wave signal is adapted as the positive(+) high voltage applied to the electrode of the positive(+) ion generator 11, a high voltage generator 20 is connected between a DC (Direct Current) power-supply unit 21 for generating a predetermined DC power-supply voltage (e.g., DC 12V) and the ion generator 10, as shown in FIG. 4. The high voltage generator 20 includes a sine wave generator 22 and an amplifier 23.

The sine wave generator 22 converts the DC power-supply voltage into a sine wave voltage having a predetermined frequency, such that the sine wave generator 22 finally outputs the sine wave voltage having the predetermined frequency. In this case, the amplifier 23 amplifies the sine wave voltage using the same polarity as that of the sine wave voltage, such that the high voltage generator 20 applies the amplified sine wave signal having a predetermined high voltage (e.g., a voltage of several kV) to the positive ion generator 11.

Also, the amplifier 23 amplifies a positive(+) DC power-supply voltage using a negative(−) high voltage (e.g., a voltage of several kV) opposite to the positive(+) DC power-supply voltage, such that the high voltage generator 20 applies the amplified voltage to the negative ion generator 12 of the ion generator 10.

A controller 24 is connected to the sine wave generator 22 such that the controller 24 establishes a frequency or on-time duty cycle of the sine wave signal.

The controller 24 includes a frequency setup unit 25 for establishing a frequency of the sine wave signal, and a duty-cycle setup unit 26 for establishing an on-time duty cycle of the sine wave signal.

The controller 24 outputs a sine wave frequency setup signal and/or an on-time duty cycle setup signal to the high voltage generator 20 according to a user-entry command received from an entry unit 27. In this case, the controller 24 searches for information stored in a storage unit 28, which stores setup information associated with a frequency or an on-time duty cycle of the sine wave signal in response to the user-entry command. The controller 24 receives frequency setup information corresponding to the sine wave signal or on-time duty cycle setup information corresponding to the sine wave signal from the storage unit 28, and establishes a frequency and on-time duty cycle of the sine wave signal. The storage unit 28 stores information indicative of the quantity of generated hydrogen ions, and other information indicative of the frequency or on-time duty cycle of the sine wave signal.

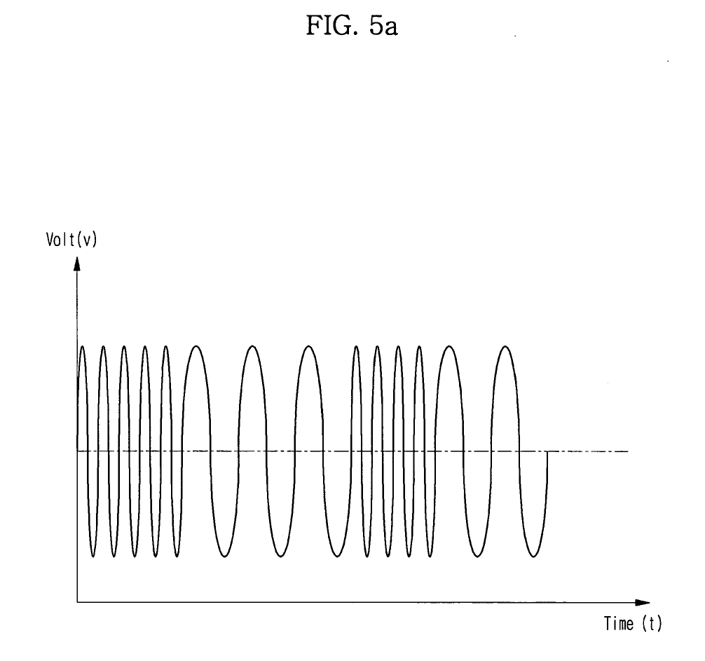

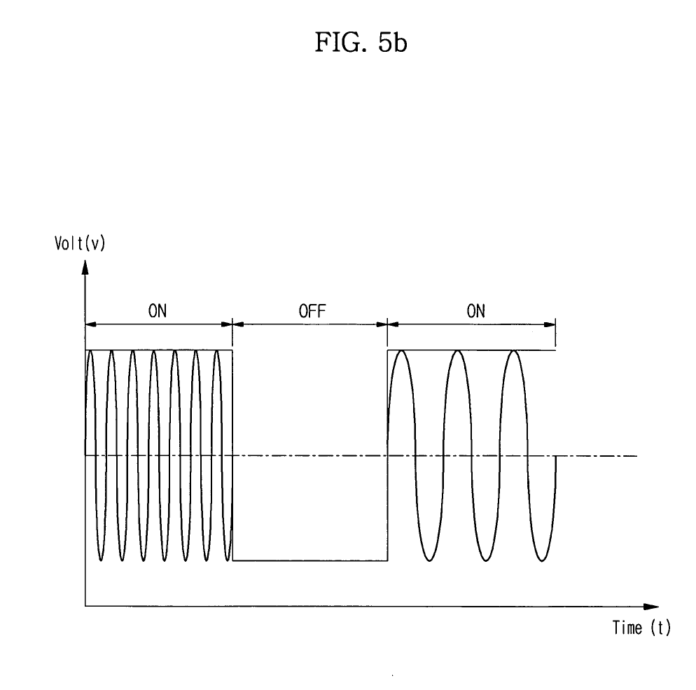

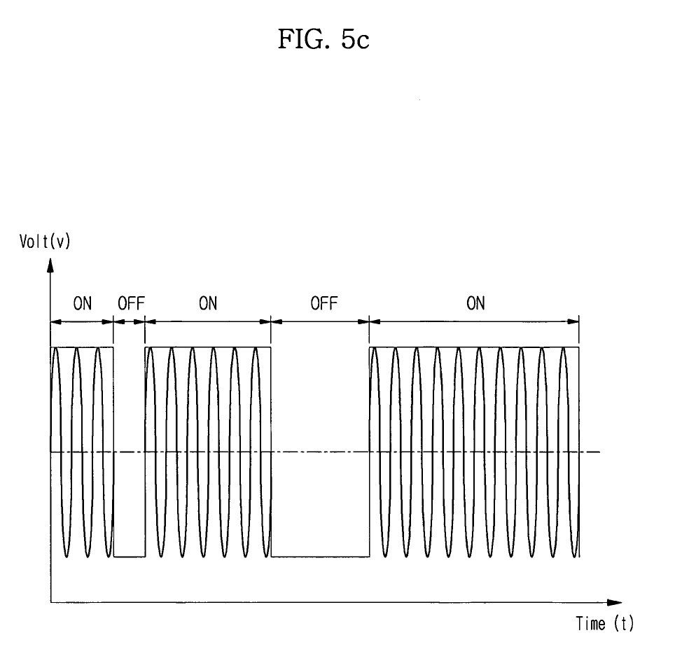

If a user establishes the quantity of generated ions using the entry unit 27, the controller 24 receives frequency setup information or on-time duty cycle information associated with the established ion generation quantity, and changes a sine wave voltage of the sine wave generator 22 using one of a frequency setup unit 25 and a duty-cycle setup unit 26. For example, if a frequency of the sine wave voltage is changed as shown in FIG. 5a, or if a frequency or on-time duty cycle of the sine wave voltage is changed as shown in FIG. 5b, the controller 24 changes the on-time duty cycle of the sine wave voltage as shown in FIG. 5c.

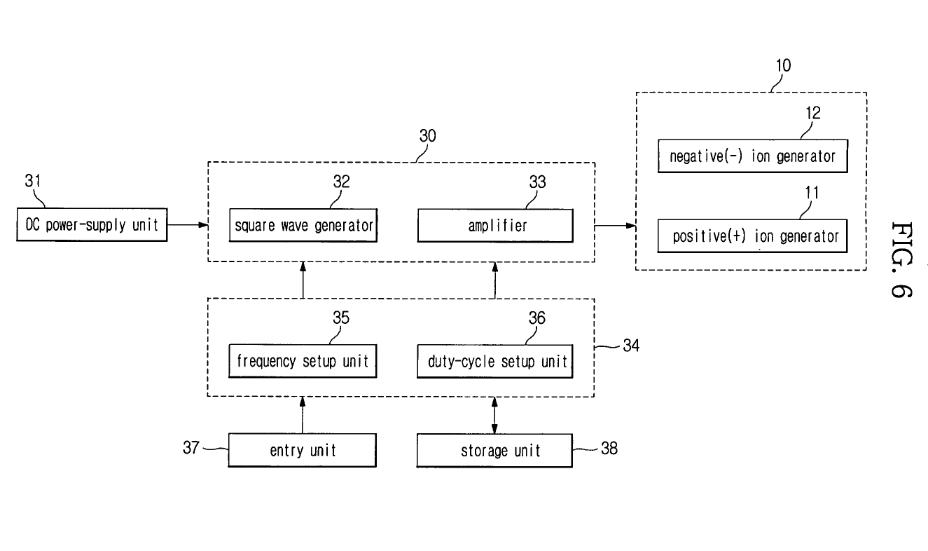

If a square wave signal is adapted as the positive(+) high voltage applied to an electrode of the positive(+) ion generator 11, a high voltage generator 30 is connected between a DC power-supply unit 31 for generating a predetermined DC power-supply voltage (e.g., DC 12V) and the ion generator 10, as shown in FIG. 6. The high voltage generator 30 includes a square wave generator 32 and an amplifier 33.

The square wave generator 32 converts the DC power-supply voltage into a square wave voltage of a predetermined frequency, such that it finally outputs the square wave voltage of the predetermined frequency. In this case, the amplifier 33 amplifies the square wave voltage using the same polarity as that of the square wave voltage, such that it applies the amplified square wave signal having a predetermined high voltage (e.g., a voltage of several kV) to the positive ion generator 11.

Also, the amplifier 33 amplifies a positive(+) DC power-supply voltage using a negative(−) high voltage (e.g., a voltage of several kV) opposite to the positive(+) DC power-supply voltage, such that it applies the amplified voltage to the negative ion generator 12.

A controller 34 is connected to the square wave generator 32 such that the controller 34 establishes a frequency or on-time duty cycle of the square wave signal.

The controller 34 includes a frequency setup unit 35 for establishing a frequency of the square wave signal, and a duty-cycle setup unit 36 for establishing an on-time duty cycle of the square wave signal.

The controller 34 outputs a square wave frequency setup signal and/or an on-time duty cycle setup signal to the high voltage generator 30 according to a user-entry command received from an entry unit 37. In this case, the controller 34 searches for information stored in a storage unit 38, which stores setup information associated with a frequency or on-time duty cycle of the square wave signal in response to the user-entry command. The controller 34 receives frequency setup information corresponding to the square wave signal or the on-time duty cycle setup information corresponding to the square wave signal from the storage unit 38, and establishes a frequency and on-time duty cycle of the square wave signal. The storage unit 38 stores information indicative of the quantity of generated hydrogen ions, and other information indicative of the frequency or the on-time duty cycle of the square wave signal.

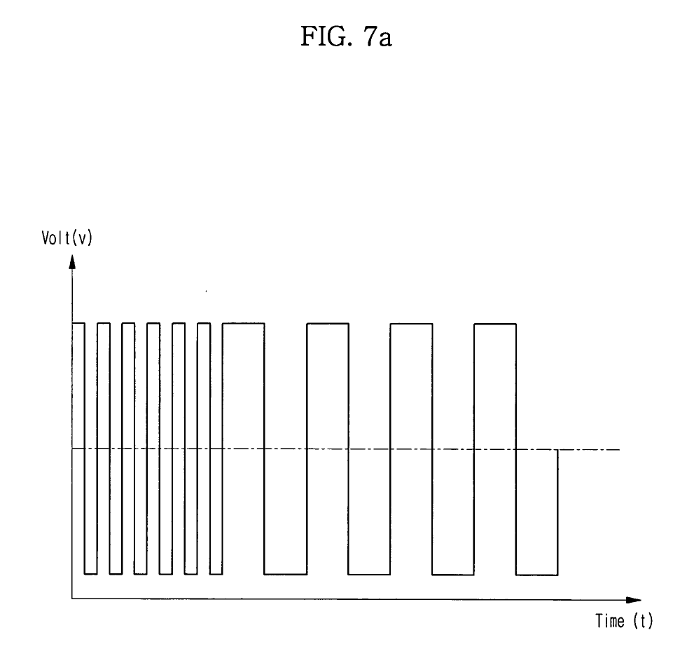

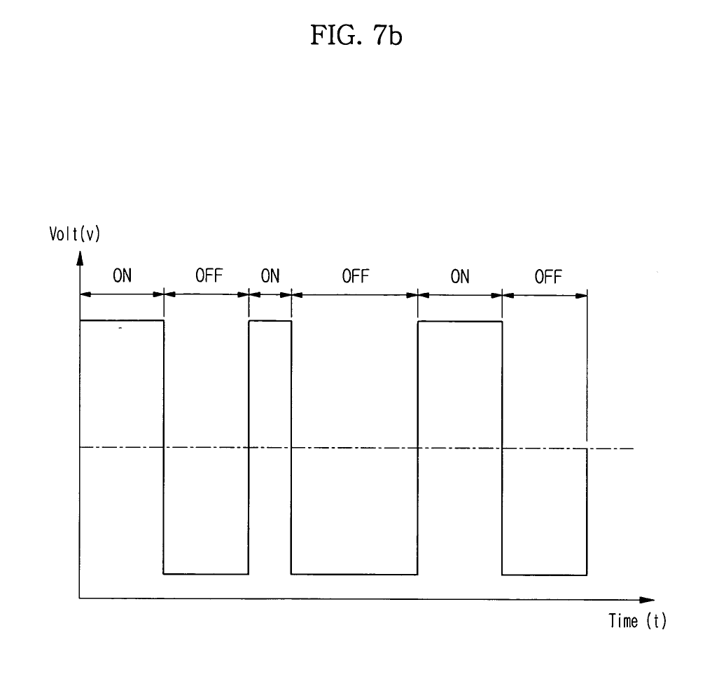

If a user establishes the quantity of generated ions using the entry unit 37, the controller 34 receives frequency setup information or on-time duty cycle information associated with the established ion generation quantity, and changes a square wave voltage of the square wave generator 32 using one of a frequency setup unit 35 and a duty-cycle setup unit 36. For example, if a frequency of the square wave voltage is changed as shown in FIG. 7a, the controller 34 changes the on-time duty cycle of the square wave voltage as shown in FIG. 7b.

In accordance with the aforementioned exemplary embodiments of the present invention, the quantity of generated ions can be adjusted by changing a frequency or on-time duty cycle of a sine or square wave high voltage applied to the positive ion generator.

As is apparent from the above description, the ion generation device according to the present invention can easily change the quantity of ions generated from the positive ion generator by changing a high voltage applied to a ceramic plate electrode, such that a user can conveniently use the ion generation device irrespective of installation environments of the ion generation device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An ion generation apparatus, comprising:
an ion generator including at least one of a positive ion generation electrode and a negative ion generation electrode, for receiving a high voltage to generate ions;
a high voltage generator for applying the high voltage to the ion generator; and
a controller for changing the high voltage applied to the ion generator.

2. The ion generation apparatus as set forth in claim 1, wherein:
the high voltage generator includes a sine wave generator for generating a sine wave signal, and
the controller includes at least one of a frequency setup unit for establishing a frequency of the sine wave signal and a duty-cycle setup unit for establishing an on-time duty cycle of the sine wave signal.

3. The ion generation apparatus as set forth in claim 2, further comprising:
an entry unit for allowing a user to establish the frequency or the on-time duty cycle of the sine wave signal having the high voltage, in which
the controller changes the sine wave signal having the high voltage according to information established by the entry unit.

4. The ion generation apparatus as set forth in claim 1, wherein:
the high voltage generator includes a square wave generator for generating a square wave signal, and
the controller includes at least one of a frequency setup unit for establishing a frequency of the square wave signal and a duty-cycle setup unit for establishing an on-time duty cycle of the square wave signal.

5. The ion generation apparatus as set forth in claim 4, further comprising:
an entry unit for allowing a user to establish the frequency or the on-time duty cycle of the square wave signal having the high voltage, in which
the controller changes the sine wave signal having the high voltage according to information established by the entry unit.

6. The ion generation apparatus as set forth in claim 2, further comprising:
a storage unit for storing information corresponding to the sine wave signal having the high-voltage and information corresponding to the quantity of generated ions.

7. The ion generation apparatus as set forth in claim 4, further comprising:
a storage unit for storing information corresponding to the square wave signal having the high-voltage and information corresponding to the quantity of generated ions.

8. The ion generation apparatus as set forth in claim 3, wherein when the frequency or the on-time duty cycle of the sine wave signal having the high voltage is changed, a quantity of generated ions is regulated.

9. The ion generation apparatus as set forth in claim 5, wherein when the frequency or the on-time duty cycle of the square wave signal having the high voltage is changed, a quantity of generated ions is regulated.

10. The ion generation apparatus as set forth in claim 2, wherein the high voltage generator includes an amplifier for amplifying the sine wave signal.

11. The ion generation apparatus as set forth in claim 4, wherein the high voltage generator includes an amplifier for amplifying the square wave signal.
